(19) United States
(12) Patent Application Publication
(10) Pub. No.: US 2003/0064698 A1
(43) Pub. Date: Apr. 3, 2003

(54) Linearization apparatus for mixer

(75) Inventors: Bumman Kim, Pohang-shi (KR); Younggoo Yang, Pohang-shi (KR); Sungmin Ock, Seongnam-si (KR)

Correspondence Address: BACON & THOMAS, PLLC, 625 SLATERS LANE, FOURTH FLOOR, ALEXANDRIA, VA, 22314

(73) Assignee: Postech Foundation, Kyungsangbuk-do (KR)

(21) Appl. No.: 09/968,532

(22) Filed: Oct. 2, 2001

(51) Int. Cl. H04B 1/26

(52) U.S. Cl. 455/313; 455/318

(57) ABSTRACT

A mixer comprises an LO (Local Oscillator) switching circuit for switching in response to an LO signal, a driver amplifier driven in response to an RF signal, an IF generator for generating an IF signal by detecting a difference between the LO signal and the RF signal, a filter for detecting a nonlinear low frequency intermodulation component of the RF signal, a low frequency amplifier for amplifying the low frequency intermodulation component and inverting a phase of the low frequency intermodulation component and an intermodulation component feed-forwarding circuit for feed-forwarding the amplified low frequency intermodulation component to output terminals of the driver amplifier or the LO switching circuit whereby the low frequency intermodulation component can be removed. The mixer removes an intermodulation component of an input RF signal generated due to the nonlinear characteristic of an RF amplifier, thereby to improve the linearity of the mixer.

### FIELD OF THE INVENTION

This invention relates to a mixer (Gilbert cell mixer); and, more particularly, to a mixer for improving the linearity thereof without losing a conversion gain of the mixer.

### BACKGROUND OF THE INVENTION

In general, a mixer is a device for mixing two input frequencies to produce another frequency. That is, the mixer takes two input frequencies, an RF signal from an antenna and a local oscillator (LO) signal, and mixes them to produce another frequency, a difference of the original frequencies. The difference is selected as an intermediate frequency (IF).

Linear characteristics of the mixer employed as a component of a wireless digital communication system are very important. A mixer of Gilbert cell structure using linearization methods such as source degeneration or modified current mirror on a translinear stage is currently well known as a way to achieve the linearity of a mixer.

Referring to FIG. 1, there is shown a conventional Gilbert cell mixer. The mixer 1 shown in FIG. 1 includes LO switching circuits, i.e., transistors Q2 and Q3, whose switches respond to LO signals, a driver amplifier, i.e., a transistor Q1, which is driven in response to input RF signals to amplify the input RF signals, an IF balun and IF matching circuit 14 for producing differences, i.e., IF signals, between the LO signals and the RF signals and matching impedance between the IF signals and its output terminal and an IF amplifier 16 for amplifying the IF signals. For reference, the mixer 1 is a single balanced mixer for making LO signals, which have a predetermined phase difference therebetween, balanced.

In the mixer 1, each of capacitors C1, C2 and C3 is connected to a gate of each of the transistors Q2, Q3 and Q1, respectively, so that a DC voltage can be stably provided thereto. For the same purpose, capacitors C4 and C5 are also connected to an input terminal of each of the IF balun and IF matching circuit 14.

The gates of the transistors Q2 and Q3 are connected to an LO balun and LO matching circuit 10 so that the LO signals with the predetermined phase difference (180°) therebetween are fed differentially into the gates of the transistors Q2 and Q3.

The gate of the transistor Q1 is connected to an RF matching circuit 12 for matching an impedance between the input RF signals and the transistor Q1 to thereby reduce reflection of the RF signals.

The mixer 1 opens to high frequencies through RF chokes Lif1 and Lif2 connected between power supply sources Vdds and drains of the transistors Q2 and Q3.

In the mixer 1, a current generated by a balanced RF signal in the transistor Q1 causes the transistors Q2 and Q3, which are differentially turned on, to mix the LO signal with the RF signal to produce IF signals (RF-LO or LO-RF), a difference between the LO signal and the RF signal. In this case, the IF signals outputted from the drains of the transistors Q2 and Q3 have a phase difference therebetween of 180°. And then, the IF signals are adjusted to have no phase difference therebetween by the IF balun and IF matching circuit 14 and are amplified by the IF amplifier 16.

In this case, a second-order intermodulation component can be introduced in a bandwidth of the RF signals, which is generated due to a nonlinear component of the transistor Q1 (a capacitance between the gate and the source of the transistor Q1). The second-order intermodulation component affects the RF signals to thereby introduce a third-order intermodulation component in the bandwidth of the RF signals outputted from a drain of the transistor Q1. Accordingly, an intermodulation component can be introduced in a bandwidth of the IF signals such that a conversion gain of the mixer is reduced and noise characteristics thereof are degraded, which results in reduced linearity of the mixer.

### SUMMARY OF THE INVENTION

It is, therefore, an object of the present invention to provide a mixer that can remove an intermodulation component generated by a nonlinear component of a transistor for amplifying an RF signal to thereby improve the linearity of the mixer. This object can be achieved by detecting a low frequency second-order intermodulation component of input RF signals, amplifying and feed-forwarding it to output terminals of the transistor or an LO switching circuit.

In accordance with the present invention, there is provided a mixer comprising: an LO (Local Oscillator) switching circuit for switching in response to an LO signal; a driver amplifier driven in response to an RF signal; an IF generator for generating an IF signal by detecting a difference between the LO signal and the RF signal; a filter for detecting a low frequency intermodulation component of the RF signal; a low frequency amplifier for amplifying the low frequency intermodulation component whereby the low frequency intermodulation component obtains a predetermined gain and an antiphase (a phase of the low frequency intermodulation component is inverted); and an intermodulation component feed-forwarding circuit for feed-forwarding the amplified low frequency intermodulation component to output terminals of the driver amplifier or the LO switching circuit whereby the low frequency intermodulation component can be removed.

### BRIEF DESCRIPTION OF THE DRAWINGS

The above and other objects and features of the present invention will become apparent from the following description of preferred embodiments given in conjunction with the accompanying drawings, in which:

FIG. 1 illustrates a conventional Gilbert cell mixer;

FIG. 2 depicts a circuit diagram for a single balanced Gilbert cell mixer in accordance with a first embodiment of the present invention;

FIG. 3 exhibits a circuit diagram for a single balanced Gilbert cell mixer in accordance with a second embodiment of the present invention;

FIG. 4 charts a circuit diagram for a double balanced Gilbert cell mixer in accordance with a third embodiment of the present invention;

FIG. 5 illustrates a circuit diagram for a double balanced Gilbert cell mixer in accordance with a fourth embodiment of the present invention.

### DETAILED DESCRIPTION OF THE PREFERRED EMBODIMENTS

In the following, referring to the accompanying drawings, preferable embodiments in accordance with the present invention will be described in detail.

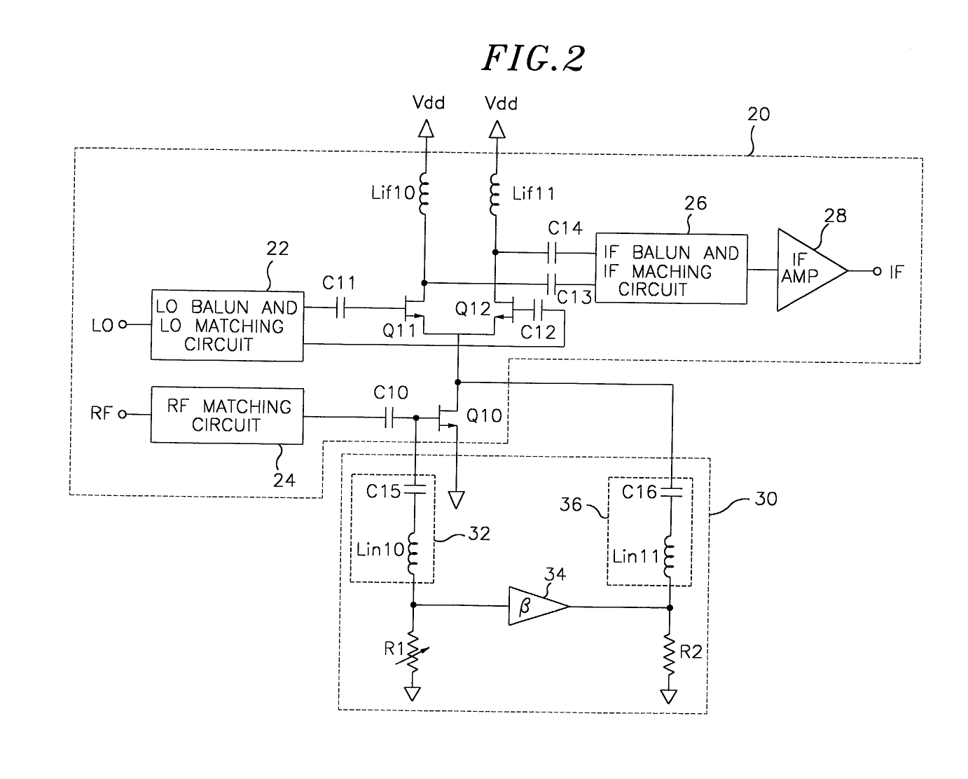

FIG. 2 illustrates a single balanced Gilbert cell mixer in accordance with a first embodiment of the present invention.

Referring to FIG. 2, the first embodiment of the present invention, which has a single balanced mixer 20 for making LO signals balanced, further has an intermodulation component feed-forwarding circuit 30 for removing an intermodulation component of an RF signal by feed-forwarding the intermodulation component to an output terminal of a transistor Q1 for RF amplification in the mixer 20.

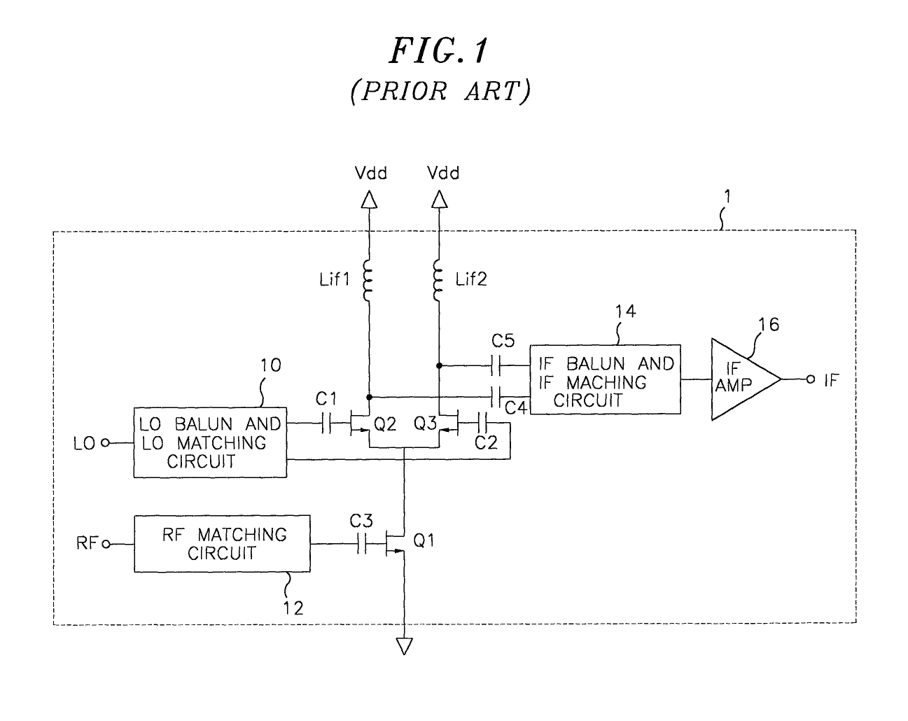

The mixer 20, a same circuit as the mixer 1 shown in FIG. 1, comprises an LO balun and LO matching circuit 22, an RF matching circuit 24, a driver amplifier Q10, LO switching circuits Q11 and Q12, RF chokes Lif10 and Lif11, an IF balun and IF matching circuit 26, an IF amplifier 28 and a plurality of capacitors C10 to C14.

The intermodulation component feed-forwarding circuit 30, which includes a filter 32 for detecting a nonlinear low frequency second-order intermodulation component of input RF signals applied to the driver amplifier Q10 and a low frequency amplifier 34 for amplifying the low frequency signal detected by the filter 32 so that the detected low frequency signal has a predetermined gain and an antiphase, removes an intermodulation component of the RF signals generated due to a nonlinear component of the driver amplifier Q10 by feed-forwarding the amplified low frequency signal to an output terminal of the driver amplifier Q10.

The intermodulation component feed-forwarding circuit 30 further includes a grounded variable resistor R1 connected to a common node for the filter 32 and the input terminal of the low frequency amplifier 34 and a grounded resistor R2 connected to an output terminal of the low frequency amplifier 34.

The filter 32 contains a capacitor C15 and an inductor Lin10 connected in series between the grounded variable resistor R1 and the driver amplifier Q10.

The intermodulation component feed-forwarding circuit 30 further includes a filter 36 which has a capacitor C16 and an inductor Lin11 connected to each other in series between the output terminal of the low frequency amplifier 34 and the output terminal (the drain) of the driver amplifier Q10 to filter out a high frequency component.

The mixer 20 in accordance with the first embodiment of the present invention generates IF signals by mixing RF signals amplified by the driver amplifier Q10 with LO signals differentially inputted to the LO switching circuits Q11 and Q12. Also, in order to remove an intermodualtion component of the RF signals generated due to the nonlinear component of the transistor Q10 (a capacitance at a gate and a source of the transistor Q10) for RF amplification, the mixer 20 and the intermodulation component feed-forwarding circuit 30 operate as follows.

The intermodulation component feed-forwarding circuit 30 detects a low frequency second-order intermodulation component of the RF signals applied to the driver amplifier Q10 through the filter 32, amplifies the detected low frequency signal through the low frequency amplifier 34 to thereby make it have a predetermined gain and an antiphase, and feed-forwards the amplified low frequency signal to the output terminal of the driver amplifier Q10. Since a phase and an amplitude of the feed-forwarded second-order intermodulation component of the RF signals are adjusted to be equal to those of the second-order intermodulation component of the RF signals generated by the transistor Q10, the second-order intermodulation components are counterbalanced with each other. In this way, the intermodulation component feed-forwarding circuit 30 in accordance with the first embodiment of the present invention can improve the linearity of the mixer 20.

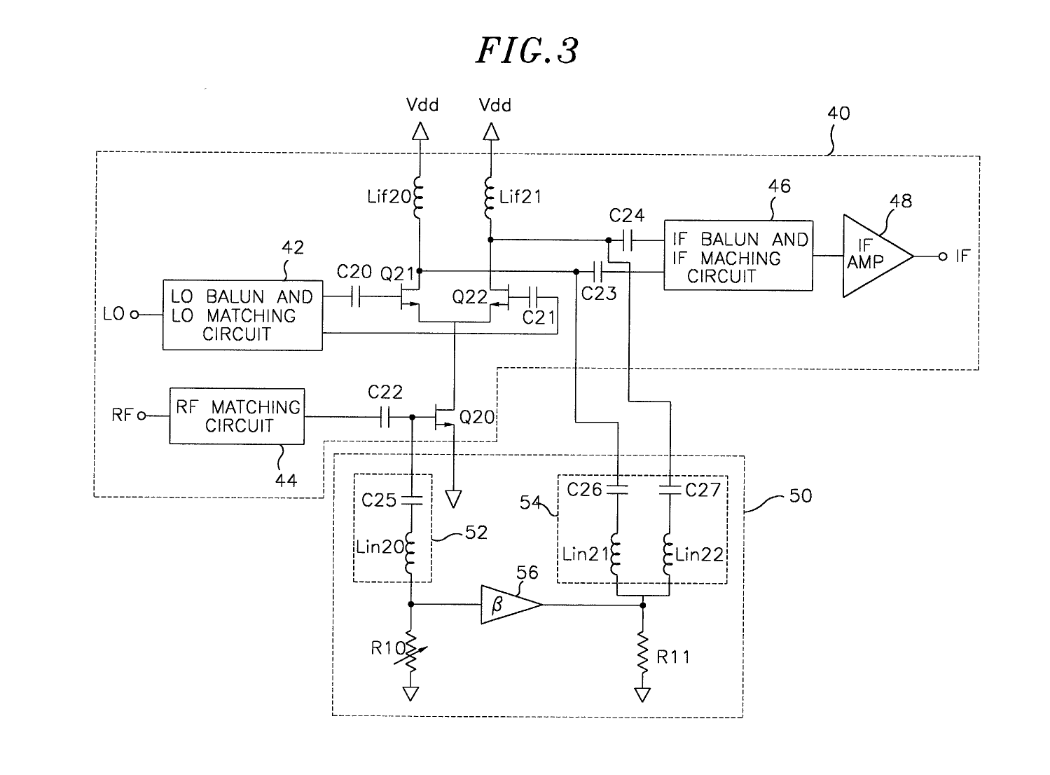

FIG. 3 shows a single balanced Gilbert cell mixer in accordance with a second embodiment of the present invention.

Referring to FIG. 3, the second embodiment of the present invention has a single balanced mixer 40 for making LO signals balanced and an intermodulation component feed-forwarding circuit 50 for removing an intermodulation component of an RF signal by feed-forwarding the intermodulation component to output terminals of LO switching circuits Q21 and Q22, a core part of the mixer 40.

The mixer 40, also a same circuit as the mixer 1 shown in FIG. 1, comprises an LO balun and LO matching circuit 42, an RF matching circuit 44, a driver amplifier Q20, LO switching circuits Q21 and Q22, RF chokes Lif20 and Lif21, an IF balun and IF matching circuit 46, an IF amplifier 48 and a plurality of capacitors C20 to C24.

The intermodulation component feed-forwarding circuit 50 comprises a filter 52 which has a capacitor C25 and an inductor Lin20 connected to each other in series to detect a nonlinear low frequency second-order intermodulation component of input RF signals applied to the driver amplifier Q20, a low frequency amplifier 56 for amplifying the detected low frequency signal to thereby make it obtain a predetermined gain and an antiphase and a filter 54 which includes a capacitor C26 and an inductor Lin21 connected to each other in series between an output terminal of the low frequency amplifier 56 and an output terminal (the drain) of the LO switching circuit Q21 and also a capacitor C27 and an inductor Lin22 connected to each other in series between the output terminal (the drain) of the low frequency amplifier 56 and an output terminal of the LO switching circuit Q22. Further, the intermodulation component feed-forwarding circuit 50 comprises a grounded variable resistor R10 connected to a common node for the filter 52 and the input terminal of the low frequency amplifier 56 and a grounded resistor R11 connected to an output terminal of the low frequency amplifier 56.

The mixer 40 in accordance with the second embodiment of the present invention generates IF signals by mixing RF signals amplified by the driver amplifier Q20 with LO signals differentially inputted to the LO switching circuits Q21 and Q22. Also, in order to remove the intermodulation component of the RF signals generated due to the nonlinear component of the transistors Q21 and Q22 (a capacitance at gates and sources of the transistors Q21 and Q22), the mixer 40 and the intermodulation component feed-forwarding circuit 50 operate as follows.

The intermodulation component feed-forwarding circuit 50 detects a low frequency second-order intermodulation component of the RF signals applied to the driver amplifier Q20 through the filter 52, amplifies the detected low frequency signal at the low frequency amplifier 56 so that the low frequency signal has a predetermined gain and an antiphase and feed-forwards the amplified low frequency signal to the output terminals of the transistors Q21 and Q22, core parts of the mixer 40. Although a third-order intermodulation component is generated from the second-order intermodulation component of the RF signals due to the nonlinearity of the transistors Q21 and Q22, a phase and an amplitude of a feed-forwarded third-order intermodulation component of the RF signals are adjusted to be equal to those of a third-order intermodulation component of the RF signals generated by the transistors Q21 and Q22 in such a way that the third-order intermodulation components are counterbalanced with each other. In this way, the intermodulation component feed-forwarding circuit 50 in accordance with the second embodiment of the present invention can improve the linearity of the mixer 40.

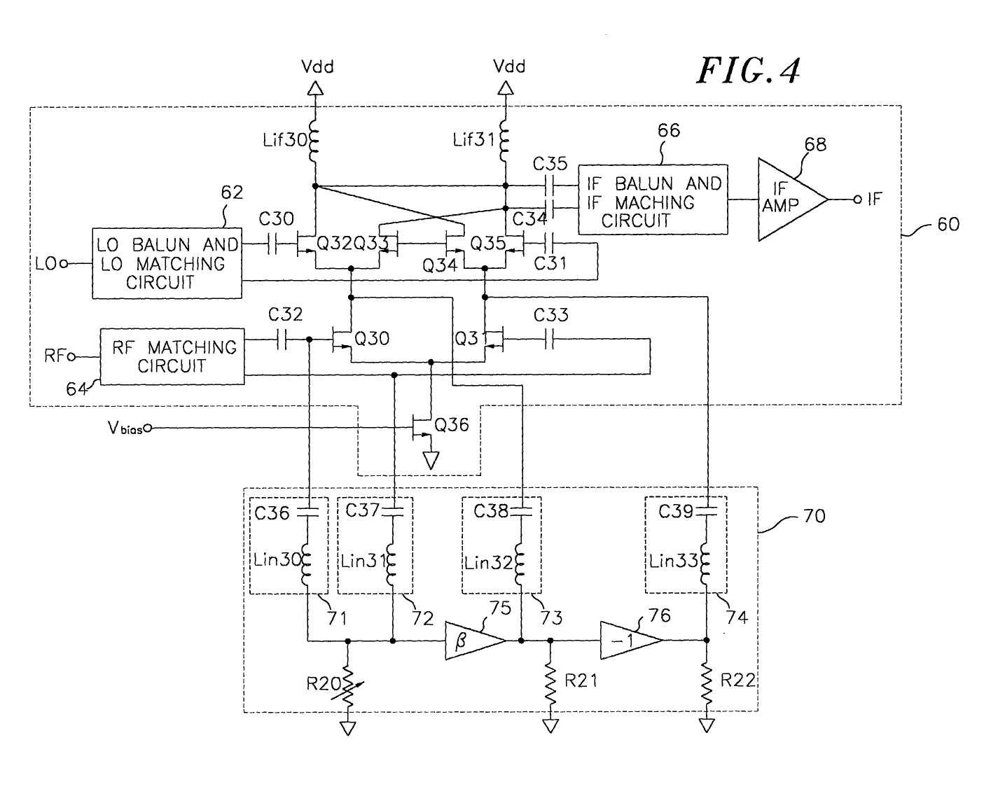

FIG. 4 shows a double balanced Gilbert cell mixer in accordance with a third embodiment of the present invention.

Referring to FIG. 4, the third embodiment of the present invention has a double balanced mixer 60 for making both LO signals and RF signals balanced and an intermodulation component feed-forwarding circuits 70 for removing an intermodulation component of an RF signal by feed-forwarding the intermodulation component to output terminals of transistors Q30 and Q31 for RF amplification.

The mixer 60 comprises an LO balun and LO matching circuit 62, an RF balun and RF matching circuit 64, driver amplifiers Q30 and Q31, LO switching circuits Q32 to Q35, RF chokes Lif30 and Lif31, an IF balun and IF matching circuit 66, an IF amplifier 68, a plurality of capacitors C30 to C35 and a bias circuit Q36.

In the mixer 60, output terminals of the transistors Q32 to Q35 are cross-connected to each other and the bias circuit Q36 is connected to a common node for sources of the driver amplifiers Q30 and Q31 to thereby generate a bias current corresponding to a bias voltage V_{bias}.

The rest of the components of the mixer 60 are similar to those of the single balanced mixers shown in FIGS. 2 and 3. Therefore, a detailed description for those components is omitted.

The intermodulation component feed-forwarding circuit 70 comprises filters 71 and 72 for detecting a nonlinear low frequency second-order intermodulation component of input RF signals applied to the driver amplifiers Q30 and Q31, a low frequency amplifier 75 for amplifying the detected low frequency signal so that the low frequency signal has a predetermined gain and an antiphase. The amplified low frequency signal is feed-forwarded to output terminals of the driver amplifiers Q30 and Q31.

The filters 71 and 72 include a capacitor C36 connected in series to an inductor Lin30 and a capacitor C37 connected in series to an inductor Lin31 respectively therein and they themselves connect respective gates of the transistors Q30 and Q31 to a variable resistor R20.

The intermodulation component feed-forwarding circuit 70 further includes an inverting amplifier 76 for inverting the amplified low frequency signal outputted from the low frequency amplifier 75. The intermodulation component of the RF signals generated by the driver amplifiers Q30 and Q31 is counterbalanced by the feed-forwarded intermodulation component outputted from the low frequency amplifier 75 and the inverting amplifier 76 to the output terminals of the driver amplifiers Q30 and Q31.

Further, the intermodulation component feed-forwarding circuit 70 further comprises a filter 73 which has a capacitor C38 and an inductor Lin32 connected to each other in series between the output terminal of the low frequency amplifier 75 and the output terminal of the transistor Q30, a filter 74 which has a capacitor C39 and an inductor Lin33 connected to each other in series between the output terminal of the inverting amplifier 76 and the output terminal of the transistor Q31, and grounded resistors R21 and R22 connected to the output terminals of the low frequency amplifier 75 and the inverting amplifier 76, respectively.

The intermodulation component feed-forwarding circuit 70 detects a low frequency second-order intermodulation component of the RF signals applied to the driver amplifiers Q30 and Q31 through the filters 71 and 72, respectively, amplifies the detected low frequency signal through the low frequency amplifier 75 and the inverting amplifier 76 so that the low frequency signal has a predetermined gain and an antiphase and feed-forwards the amplified low frequency signal to the output terminals of the driver amplifiers Q30 and Q31. Since an amplitude and a phase of the feed-forwarded second-order intermodulation component of the RF signals are adjusted to be equal to those of a third-order intermodulation component of the RF signals generated by the transistors Q30 and Q31, respectively, the intermodulation components are counterbalanced with each other. In this way, the intermodulation component feed-forwarding circuit 70 in accordance with the present invention can improve the linearity of the mixer 60.

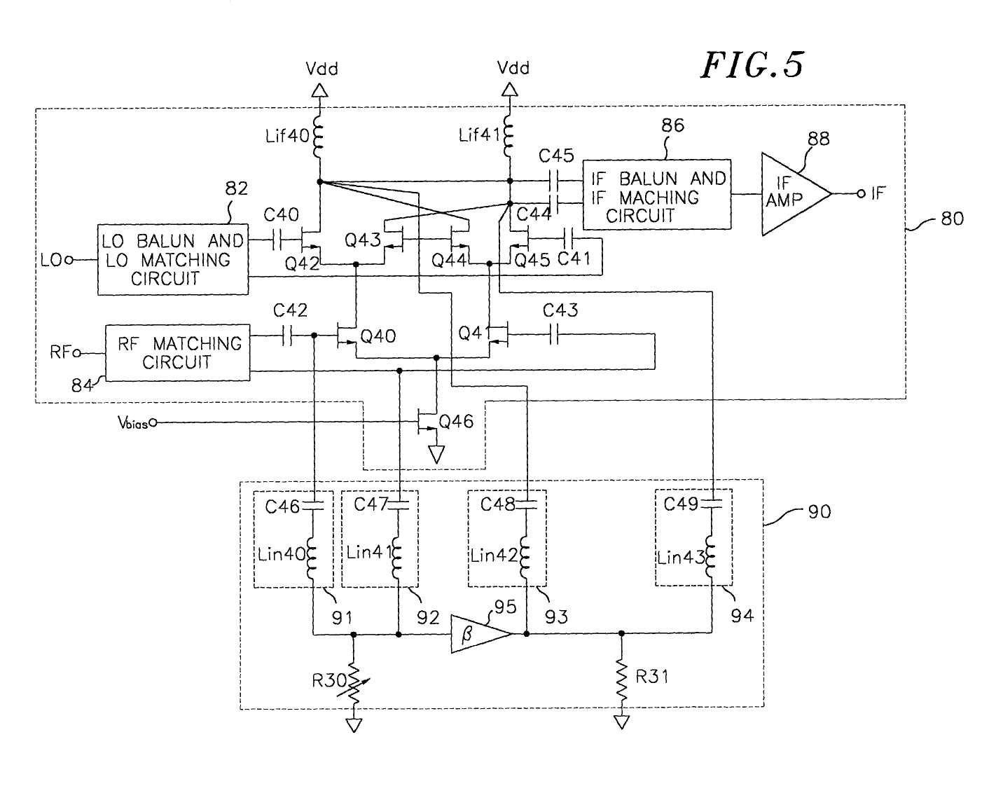

FIG. 5 shows a double balanced Gilbert cell mixer in accordance with a fourth embodiment of the present invention.

Referring to FIG. 5, a fourth embodiment of the present invention has a double balanced mixer 80 for making both LO signals and RF signals balanced and an intermodulation component feed-forwarding means 90 for removing an intermodulation component of an RF signal by feed-forwarding the intermodulation component to output terminals of LO switching circuits Q42 and Q45, core parts of the mixer 80.

The mixer 80, a same circuit as the mixer 60 shown in FIG. 4, comprises an LO balun and LO matching circuit 82, an RF balun and RF matching circuit 84, driver amplifiers Q40 and Q41, LO switching circuits Q42 to Q45, RF chokes Lif40 and Lif41, an IF balun and IF matching circuit 86, an IF amplifier 88, a plurality of capacitors C40 to C45 and a bias circuit Q46.

Since the components of the mixer 80 are similar to those of the mixer 60 shown in FIG. 4, a detailed description for those components is omitted.

The intermodulation component feed-forwarding circuit 90 comprises filters 91 and 92 for detecting a nonlinear low frequency second-order intermodulation component of input RF signals applied to gates of the driver amplifiers Q40 and Q41, a low frequency amplifier 95 for amplifying the detected low frequency signal so that the low frequency signal has a predetermined gain and an antiphase. The amplified low frequency signal is feed-forwarded to output terminals of the LO switching circuits Q42 and Q45.

Although a third-order intermodulation component is generated by the combination of the second-order intermodulation component of the RF signals outputted from the driver amplifiers Q40 and Q41 and the RF primary signals due to the nonlinearity of the LO switching circuits Q42 and Q45, an amplitude and a phase of the feed-forwarded third-order intermodulation component of the RF signals are adjusted to be equal to those of a third-order intermodulation component of the RF signals generated by the transistors Q40 and Q41, whereby the third-order intermodulation components are counterbalanced with each other. In this way, the intermodulation component feed-forwarding circuit 90 in accordance with the present invention can improve the linearity of the mixer 80.

While the invention has been shown and described with respect to the preferred embodiments, it will be understood by those skilled in the art that various changes and modifications may be made without departing from the spirit and scope of the invention as defined in the following claims.

What is claimed is:

1. A mixer comprising:
an LO (Local Oscillator) switching circuit for switching in response to an LO signal;
a driver amplifier driven in response to an RF signal;
an IF generator for generating an IF signal by detecting a difference between the LO signal and the RF signal;
a filter for detecting a low frequency intermodulation component of the RF signal;
a low frequency amplifier for amplifying the low frequency intermodulation component whereby the low frequency intermodulation component can obtain a predetermined gain and an antiphase; and
an intermodulation component feed-forwarding circuit for feed-forwarding the amplified low frequency intermodulation component to output terminals of the driver amplifier or the LO switching circuit whereby the low frequency intermodulation component can be removed.

2. The mixer of claim 1, further comprising:
a grounded variable resistor connected to a common node of input terminals of the filter and the low frequency amplifier; and
a grounded resistor connected to an output terminal of the low frequency amplifier.

3. The mixer of claim 2, wherein the filter includes a capacitor and an inductor connected to each other in series between the driver amplifier and the grounded variable resistor.

4. The mixer of claim 1, wherein the intermodulation component feed-forwarding circuit includes a capacitor and an inductor connected to each other in series whereby a high frequency component of the amplified low frequency intermodulation component can be filtered out.
